(19) United States
(12) Patent Application Publication
(10) Pub. No.: US 2006/0281489 A1
(43) Pub. Date: Dec. 14, 2006

(54) Electronic device with calendar function

(75) Inventor: Hanns-Ingo Maack, Norderstedt (DE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/571,832

(22) PCT Filed: Sep. 10, 2004
(86) PCT No.: PCT/IB04/51736

§ 371 Date: Mar. 15, 2006

(30) Foreign Application Priority Data
Sep. 19, 2003 (EP) 03103452.3

(51) Int. Cl. H04M 1/00; H04B 1/38

(52) U.S. Cl. 455/556.2; 455/566

(57) ABSTRACT

The invention relates to an electronic device (1), particularly a mobile telephone, comprising a display module (2), an input module (3) and an information module (4, 5, 6). The device (1) can be operated in a plurality of information modes and an information mode can be activated as a function of time. The device (1) furthermore has a calendar function which makes it possible to store an appointment for predeterminable periods of time or points in time. In order to provide an electronic device in which an information mode can be set in a user-friendly way, and in which it is easy to modify the information mode and disturbance of the surroundings due to an unsuitable information mode are avoided, is proposed that the information mode should be assigned to information about the appointment, and/or for information during the appointment, when an appointment is being put in by means of the input module (3).

The present invention relates to an electronic device comprising a display module, an input module and an information module, wherein the device can be operated in a plurality of information modes and an information mode can be activated as a function of time, the device has a calendar function which makes it possible to store an appointment for predeterminable periods of time or points in time. The invention furthermore relates to a mobile telephone, and to a method for controlling an electronic device comprising a calendar function.

Electronic devices, especially mobile telephones, PDAs, smart phones or other organizers have, among other things, calendar and organizer functions in which appointments with a given start and end time can be managed. These devices also comprise reception units, in order to make it possible to receive messages, for example an SMS or an incoming telephone call. Such devices can be operated in a plurality of information modes, and it is possible to select between individual information modes according to the situation of the surroundings. The information mode to be used is usually selected manually.

WO 98/07265 describes a programmable mobile telephone with a schedule, according to which the mobile telephone can be activated and deactivated. The schedule can be modified by the user of the mobile telephone. By comparison with a clock time, a controller automatically monitors whether the mobile telephone should currently be switched on or switched off. The patent discloses that other functions of the mobile telephone can be switched on or off by means of the controller, according to the programming of the schedule.

On the basis of this, it is an object of the present invention to provide an electronic device in which an information mode can be set in a user-friendly way, and in which it is easy to modify the information mode.

This object is achieved in that, for each appointment, the information mode can be assigned to information about the appointment, and/or for information during the appointment, when an appointment is being put in by means of the input module.

The invention is based on the idea that the electronic device should inform the user differently according to the situation when messages arrive before and/or during an appointment entered in the calendar.

Switching the functions of the electronic device on and off purely as a function of time, as is known in the prior art, is unsuitable since the device is not responsive to surroundings or appointments when it is switched on. The information mode has to be set manually as a function of time, which is onerous and may often be forgotten. The caller can only speak to an answerphone when the device is switched off, even though the user may sometimes be able to take a call or read an incoming message, for example because of a pause in the conversation. Variations in the daily routine have to be accommodated for in an elaborate way by changing the schedule.

To that end, the invention proposes that at times for which the user has entered input appointments in the calendar, the electronic device should be switched to an information mode which can be assigned in accordance with the type of appointment when it is being put in. The information about what type of appointment it is can be assigned straightforwardly when the appointment is being put in, so that an appropriate information mode can be selected. In periods of time for which appointments with a start and/or end time are input in the calendar, it is therefore possible for the electronic device to be switched automatically to an information mode which is suitable for the requirements of the surroundings during the appointment.

The invention proposes that an information mode should be assigned for this appointment and an information mode should also be assigned for incoming messages during the appointment.

The advantage of this configuration is that the user of the electronic device is reachable during the appointments without disturbing others or that, because of noisy surroundings, he or she can assign an information mode which makes it possible to notice an incoming message.

Other advantageous configurations can be found in the dependent claims.

In an advantageous configuration of the invention, when an appointment is put in, the information mode can be activated as a function of an appointment category assigned to the appointment. Appointments have similarities in terms of their information mode requirements, so that it is possible to group the appointments into appointment categories. The appointment categories are then respectively associated with an information mode so that, by selecting an appointment category, the allocated information mode is automatically selected and activated at the time of the appointment. This facilitates straightforward assignment of the information mode.

In another advantageous configuration of the invention, an information mode appropriate to the time of the appointment is assigned to the appointment. This has the advantage that the user can select an information mode which, for example, is appropriate to the time for which the appointment is planned, without extra input work.

In another advantageous configuration of the invention, the information mode for the appointment may be different to the information mode during the appointment. The electronic device reminds the user about an appointment, the user normally being in a different situation at this time than during the appointment. It is therefore advantageous to be able to freely select the information mode for the appointment while not being bound to the information mode for incoming messages or information during the appointment. If an information mode is not selected for the appointment, then the time-dependent information mode may be automatically selected and activated.

In another configuration of the invention, the appointment category-dependent activation of the information mode can be reactivated after a time-dependent activation of an information mode has been concluded. Time-dependent activation of the information mode is necessary, in particular, whenever occasional events occur and the user has set the electronic device to an information mode determined by him or her for a particular time. The advantage of this is, after this time-dependent activation of an information mode has been concluded, that the electronic device is reset to the appointment category-dependent activation so that the information modes can be selected and activated as a function of the appointments entered in the calendar. It is also advantageous for the electronic device to be switched to a time-dependent information mode at times when for which no appointments have been entered in the calendar. This allows substantial adaptation of the information type to regularly recurring conditions, for example during the working day. At times when the user is driving to work, for example, an information mode which is suitable for noisy surroundings may be selected. On the other hand, an information mode which is suitable for normal or quiet surroundings may be activated at times when the user is sitting in the office. An information mode which does not generate any noise may moreover be selected at night. This has the advantage that it is possible to be given information and take messages or telephone calls even when working at nighttime, while other people are not in principle disturbed. The electronic device furthermore needs less energy with this type of information, so that the time until the next battery charge is advantageously extended.

Advantageously, the information module may emit information of an acoustic and/or visual and/or tactile type. The three possible types of information allow a combination of information types to be defined for each appointment, or for each appointment category.

In another configuration of the invention a periodicity, for example daily, weekly, monthly or yearly, can also be assigned to each appointment, in addition to the appointment category. This reduces the work for putting in recurrent appointments.

It is also advantageous if the user can freely set the information mode by combining the different types of information, so that the user can define the information modes according to individual requirements.

The object is also achieved by a mobile telephone as claimed in claim 9.

The object is also achieved by a method for controlling an electronic device comprising a calendar function, in which an appointment category from a collection of appointment categories is selected for each appointment and an information mode is allocated to each appointment category, and in which the electronic device is switched to the allocated information mode for the appointment at the time of the appointment.

These and other aspects of the invention are apparent from and will be elucidated with reference to the embodiments described hereinafter.

In the drawings:

FIG. 1 shows a block diagram of a mobile telephone according to the present invention;

FIG. 2 shows a flow chart for assigning an information mode according to the present invention;

FIG. 3 shows a flow chart for automatically setting the information mode according to the present invention.

The electronic device 1 may, for example, be a mobile telephone 1 as shown in FIG. 1. The mobile telephone 1 is schematically shown and comprises a display module 2 and an input module 3. By means of an information module 4, 5, 6, the user is informed about incoming calls or messages, and about events which are entered in a calendar. The information module 4, 5, 6 comprises a visual information module 4, for example in the form of an LED, an acoustic information module 6 in the form of a loudspeaker, which plays a ring-tone or a tune, and a tactile information module 5 which makes the telephone or electronic device vibrate. The tactile information module 5 is generally referred to as a vibration alarm. The display module 2 may be used simultaneously or instead of the single LED for the visual information module 4.

FIG. 2 represents a flow chart of the assignment of an information mode to corresponding appointments. Then the calendar function is called up in step 20. The user can use the input module 3 to put in an appointment with a start and end time (step 21). After he or she has put in the appointment with a start and end time, an appointment category is selected in step 22. A query is made in step 23 as to whether a preset information mode is to be assigned to the selected appointment category. If a preset information mode is to be set, then the appointment is stored with the assigned preset information mode (step 24). If none of the preset information modes is required for the selected appointment category, then the program continues with step 25 in which an information mode can be selected from a collection of information modes. Step 26 asks whether a previously defined information mode should be assigned to the corresponding appointment. If a defined information mode is to be assigned to the corresponding appointment, then this appointment with the selected information mode is selected in step 27 and stored in step 24. If none of the defined information modes is suitable for this appointment and the appointment category, then the information mode is defined in step 28. This involves, for example, setting the activation of the three different information types, or a combination of the various information types. After the information mode has been defined in step 28, the appointment is stored in the defined information mode in step 25. After this, a query is made in step 29 as to whether another appointment is to be put in. If so, the program sequence is repeated; if not, the program is terminated in step 30.

FIG. 3 shows another flow chart. This flow chart shows how the mobile telephone 1 establishes by a control mechanism, for example using a controller (not shown), whether or not it should change the information mode. The operating program is started at predeterminable intervals by the controller. After the start 32, a query is made in step 33 as to whether a preset duration for an information mode has elapsed. If the preset duration for the information mode that is currently set has not yet elapsed, the program is terminated and called up again by the controller at a presettable later time. If the preset duration for the set information mode has elapsed, a check is made in a subsequent query (step 34), as to whether the current clock time coincides with an appointment entered in the calendar. If the current clock time does not coincide with the start time of an appointment, then the mobile telephone 1 remains in the time-dependent information mode (step 35). If the current clock time coincides with the start time of the appointment, then the mobile telephone 1 is set to the information mode assigned to this appointment (step 36). The program then remains in this loop (step 40) until the end time of the appointment has been reached, the controller being able to terminate the program if other events occur. A check is made as to whether the current clock time coincides with the end time of the appointment (step 37). If the current clock time coincides with the end time of the entered appointment, then the information mode that is assigned to this appointment is deactivated in step 38 and the mobile telephone 1 is reset to the time-dependent information mode. The program is then terminated (step 39) and can be run again.

If occasional events occur, for example a visit to a film theater, then the mobile telephone 1 can be manually switched to a suitable information mode for a preset duration. After this preset duration has elapsed, the mobile telephone 1 is automatically reset to either the appointment category-dependent or time-dependent information mode, so that the mobile telephone 1 has the correct or convenient information mode at any point in time and no disturbance of the surroundings is created, or incoming calls are not disadvantageously diverted to the mailbox or the answerphone because of an incorrect information mode, even though the- user of the mobile telephone was still capable of taking the call or being told about a corresponding appointment.

Whatever the configuration according to the invention, as known in the prior art, it is possible to place the mobile telephone permanently in an information mode so that this function according to the invention can be turned on or off manually.

For example, this makes it possible to leave the mobile telephone 1 turned on at night, although it is switched to a silent information mode in which the energy consumption is reduced by about 30 percent since only visual information is provided.

The configuration according to the invention provides a mobile telephone in which the calendar function is used to select a suitable information mode. The information put into the calendar is evaluated in such a way that the correct information mode is selected according to the type of appointment. No additional adjustment of the information mode is required in principle, so that the information mode can be set in a user-friendly way and inadvertent disturbance of the surroundings can be reduced.

### KEY TO THE FIGURES

FIG. 2:

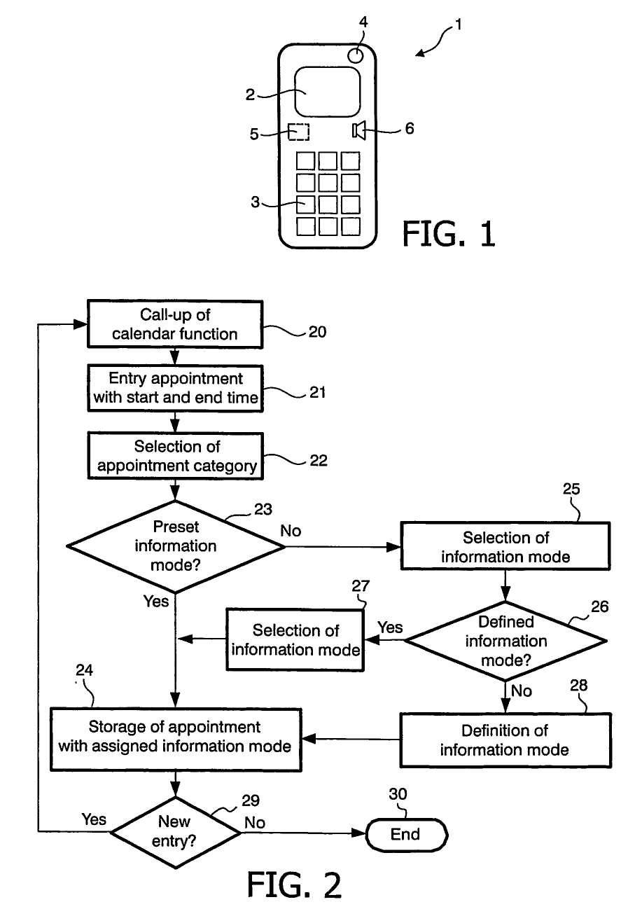

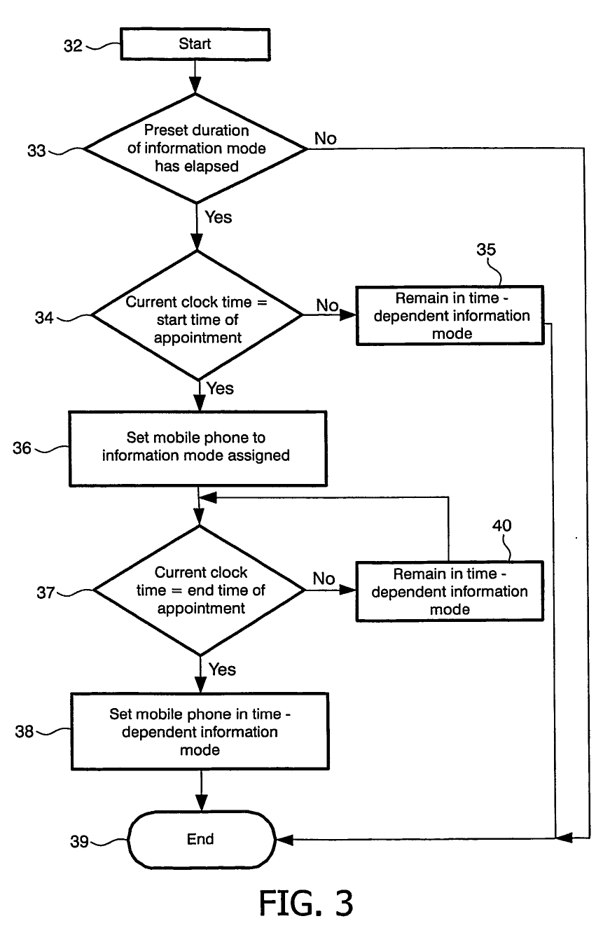

20 Call up calendar function
21 Input appointment with start and end times
22 Select appointment category
23 Preset information mode?
   YES
24 Store of the appointment with assigned information mode
   NO
25 Select information mode
26 Defined information mode?
   YES
27 Select information mode
   NO
28 Information mode definition
29 Input another appointment?
   YES
   NO
30 END
   FIG. 3:
32 Start
33 Preset duration of information mode elapsed?
   YES
   NO
34 Current clock time=appointment start time?
   NO
35 Remain in time-dependent information mode
   YES
36 Set information module to assigned information mode
37 current clock time=appointment end time?
   YES
38 Set information module to time-dependent information mode
39 End
   NO
40 Remain in assigned information mode

1. An electronic device (1) comprising a display module (2), an input module (3) and an information module (4, 5, 6), wherein the device (1) can be operated in a plurality of information modes and an information mode can be activated as a function of time; the device (1) has a calendar function which makes it possible to store an appointment for predeterminable periods of time or points in time, wherein the information mode can be assigned to information about the appointment, and/or for information during the appointment, when an appointment is being put in by means of the input module (3).

2. A device (1) as claimed in claim 1, characterized in that the information mode can be activated as a function of an appointment category assigned to the appointment.

3. A device (1) as claimed in claim 1, characterized in that the information mode is appropriate to the time of the appointment.

4. A device as claimed in claim 1, characterized in that the information mode to provide information about the appointment is different to that for providing information during the appointment.

5. A device as claimed in claim 1, characterized in that the appointment category-dependent activation of the information mode can be activated after a time-dependent activation of an information mode has been concluded.

6. A device as claimed in claim 1, characterized in that the information module (4, 5, 6) emits acoustic and/or visual and/or tactile information.

7. A device (1) as claimed in claim 1, characterized in that a periodicity can be assigned to each appointment.

8. A device (1) as claimed in claim 1, characterized in that a combination of information types can be defined in an information mode.

9. A mobile telephone (1) as claimed in claim 1.

10. A method for controlling an electronic device (1) comprising a calendar function, in which an appointment category from a collection of appointment categories is selected for each appointment and an information mode is allocated to each appointment category, and in which the electronic device (1) is switched to the allocated information mode for the appointment.
